(19) United States
(12) Patent Application Publication
(10) Pub. No.: US 2003/0209636 A1
(43) Pub. Date: Nov. 13, 2003

(54) Bobbin electromagnetic field propulsion vehicle

(76) Inventor: John Quincy St.Clair, San Juan, PR (US)

Correspondence Address: John St.Clair, Hyperspace Research Institute, 52 Kings Court, 4A, San Juan, PR, 00911, US

(21) Appl. No.: 10/142,583

(22) Filed: May 9, 2002

(51) Int. Cl. B64G 1/32

(52) U.S. Cl. 244/166

(57) ABSTRACT

This invention relates to a spacecraft which generates its own magnetic moment and magnetic field gradient in order to produce lift on the hull. The magnetic moment is generated by a large area solenoid located in the hull. A toroidal core wrapped with electrical bobbins at intervals along said core produces a traveling magnetic wave along its surface. This magnetic wave creates a spacetime curvature, similar to a tilted plate, which causes the formation of a magnetic field gradient. Power is not critical because the system uses a magnetic vortex wormhole generator to lower the speed of light in order to efficiently create highly relativistic fields due to Lorentz transformation.

### BRIEF SUMMARY OF THE INVENTION

This invention, which is the subject of my present application, is comprised of a toroidal core around which are wound a plurality of electromagnetic bobbins. The bobbins are pulsed electrically to create an amplified magnetic wave that travels around the core. At the same time, a circular electrical conductor carrying direct current creates a magnetic field around its area which results in the formation of a magnetic moment. This magnetic moment, together with the spacetime curvature distortion created by the traveling magnetic wave, produces a lift force on the vehicle.

### REFERENCE PAPERS

Levitron, Hones, U.S. Pat. No. 5,404,062.

Geometry of Electromagnetic Systems, Paul Hammond, page 179.

### BACKGROUND OF THE INVENTION

The idea for this invention comes from experiments I have done using thin transformer laminations wound in intervals with bobbins of wire connected to a frequency generator. Pulsing the bobbins electrically creates a slow traveling magnetic wave along the surface of the lamination. The velocity of the wave, as shown by Hammond in the reference paper, is the square root of the frequency divided by the conductivity and permeability of the material. From Einstein's General Theory of Relativity, this type of wave around the circumference creates a spacetime curvature distortion in the vertical direction that looks like a tilted plate. The magnetic field traveling around the circumference has to follow this curvature. This creates a magnetic gradient in the z-direction which together with the magnetic moment developed by a solenoid produces lift on the vehicle.

### SUMMARY OF THE INVENTION

It is the object of this invention to create a magnetic field gradient and magnetic moment in order to produce a lift force on the hull of a vehicle. The magnetic field gradient is produced by a traveling magnetic wave which produces a tilting-plate spacetime curvature around the hull. The magnetic moment is created by a simple circular wire carrying direct current around its area.

### STATEMENT REGARDING FEDERALLY SPONSORED RESEARCH OR DEVELOPMENT

Not Applicable.

### A BRIEF DESCRIPTION OF THE DRAWINGS

FIG. 1. The lift force on the vehicle is equal to a magnetic moment times the magnetic field gradient.

FIG. 2. Magnetic moment μ created by direct current I flowing counterclockwise around the wire coil. Cylindrical coordinates are shown to the right.

FIG. 3. The wire coil solenoid creates a magnetic field in the z-direction equal to the permeability of space times the number of turns per length of the solenoid times the current in the windings.

FIG. 4. Perspective view of bobbin spacecraft.

FIG. 5. Magnetic wave velocity along core.

FIG. 6. The g metric tensor in cylindrical coordinates with the sinusoidal wave function in the {t,θ} slots.

FIG. 7. The spacetime curvature G_{zz} in the vertical direction created by the magnetic wave traveling around the core.

FIG. 8. Tilted plate spacetime curvature showing magnetic gradient.

### DETAILED DESCRIPTION OF THE INVENTION

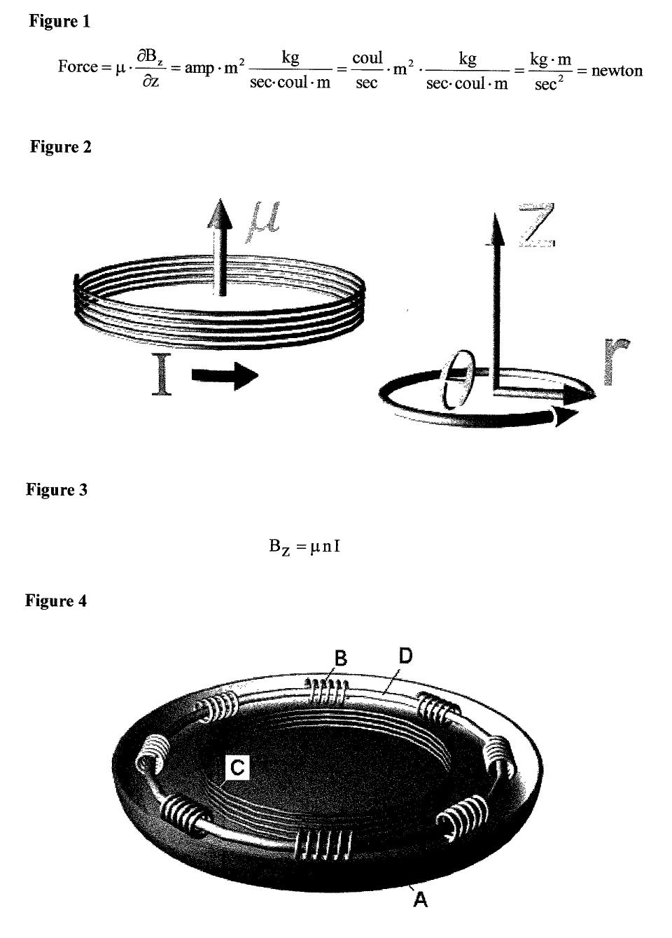

1. Referring to the equation in FIG. 1, the lift force on the bobbin spacecraft is equal to its magnetic moment times its magnetic field gradient. The magnetic moment has units of electrical current, measured in amps, times the area enclosed by the current. Thus the units of the magnetic moment are amp−m². The magnetic moment can be created by a large, circular coil of wire carrying direct current I as shown in FIG. 2. The spacetime cylindrical coordinates {t, r, θ, z} are shown to the right of the drawing where t is time, r the radius, the horizontal angle θ, and the vertical height z.

2. The wire coil solenoid also produces a magnetic field in the vertical z-direction equal to the permeability of space μ times the number of turns per unit length of the solenoid n, times the current I in the winding. The equation is shown in FIG. 3 which can be developed from Ampere's law that the magnetic field around a loop is equal to the current passing through the loop.

3. Referring to FIG. 4, the bobbin spacecraft consists of a large, horizontal, highpermeability toroidal core (D) wrapped at intervals with electrical bobbins (B) which can be pulsed electrically to create a traveling magnetic wave around the core. Interior to this core is a large direct current solenoid (C) which produces said magnetic field in the z-direction. These devices are enclosed in a circular hull (A) containing the coils on the outer rim and a cabin area in the center.

4. Referring to FIG. 5, the velocity of the magnetic wave on the surface of the core is equal to the square root of the wave frequency ω divided by the conductivity a times the permeability μ of the core material. When the first bobbin is pulsed, a wave starts to propagate along the surface of the core. As the wave passes the second bobbin in sequence, another electrical pulse is generated to amplify the wave. After many cycles, the wave traveling around the core becomes larger and larger in amplitude.

5. A traveling wave has a wave function equal to a sinusoidal function with an argument of the angle θ around the periphery less the time t, or Sin[θ−ωt].

6. In gravitational physics, there is a g metric tensor which is a measure of length in spacetime coordinates. When mass or electromagnetic fields are involved in a certain region of space, a curvature of space is created. The curvature of space can then be calculated directly from this metric tensor. The result is Einstein's G curvature tensor which shows the spacetime distortion. The g metric tensor is a 4 by 4 matrix having rows and columns equal to time t, radius r, angle theta, and vertical height z. The diagonal from top left to bottom right has a signature equal to {−1, 1, r², 1}.

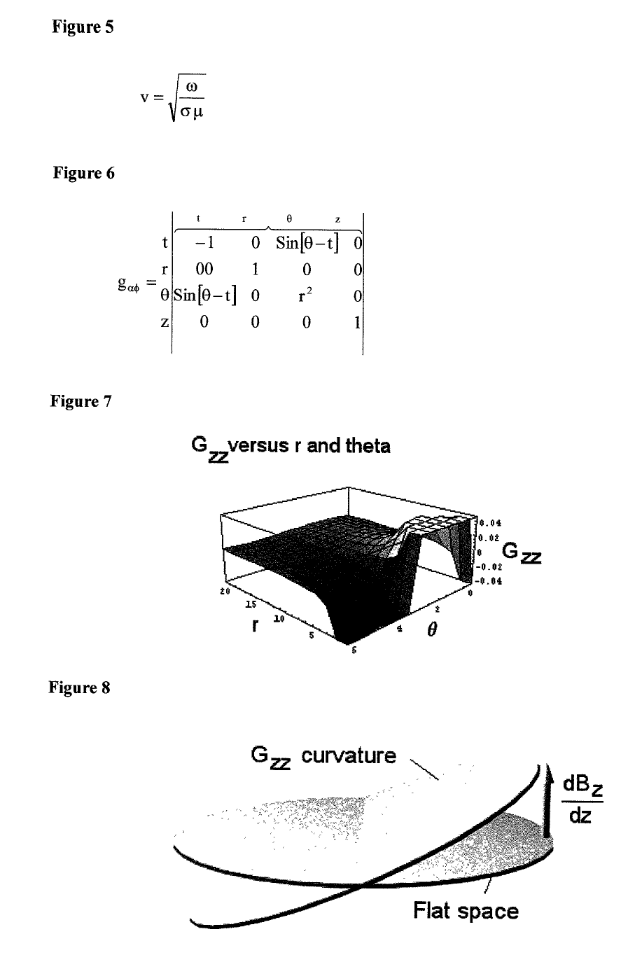

7. Because the magnetic wave traveling around the core is varying with time t in the theta direction, the wave function has to go into the {t,θ} and {θ,t} slots of the metric tensor, as shown in FIG. 6.

8. From this metric tensor, Einstein's G curvature tensor is calculated using a general relativity software program. The spacetime curvature in the vertical z-direction is contained in the G_{zz} component. A 3D plot of this curvature with respect to radius and theta is shown in FIG. 7. The axis on the right side is the angle around the periphery, and the axis on the left is the radius which goes from 0 to 20 meters. The vertical axis of the graph is the spacetime curvature in the vertical z-direction. The center of the vertical axis is zero. At a small radius, there is a sinusoidal curvature which is positive from 0 to π and which is negative from π to 2π. What this looks like is a tilted plate as depicted in FIG. 8.

9. In flat spacetime with no electromagnetic fields or mass, the curvature would be the horizontal plate as seen FIG. 8. Due to the traveling magnetic wave, the spacetime curvature looks like the tilted plate. The flat-space magnetic field was pointing up in the vertical direction, having no divergence and no gradient. In curved spacetime, however, the magnetic field becomes tilted just like the plate and a magnetic gradient dB_{z}/dz is created. This spacetime curvature gradient of the magnetic field times the magnetic moment of the second coil produces a lift force on the hull which is anchored to these coils.

What I claim as my invention is:

1. A spacecraft that generates a magnetic moment and a magnetic field gradient in the vertical direction in order to create a lift force on the hull.

2. A toroidal core wrapped with electrical bobbins at intervals around the core whose purpose is to create and amplify a magnetic wave that travels along the surface of the core.

3. A circular, direct-current carrying solenoid, located radially inside the toroidal core, to create the magnetic moment.

4. Said magnetic surface wave creates a spacetime curvature, similar to a tilted plate, which produces a magnetic field gradient in the vertical direction.

5. A circular hull, with interior cabin, electrical power supply to drive the coils, and a computer to calculate and sequence the activation of the electrical bobbins.

6. Magnetic sensors, in the form of small coils, located on the toroidal core which can detect the velocity and position of the traveling magnetic wave as feedback to the computer control system.

7. A magnetic vortex generator, either rotating magnet or dual coil, to produce a wormhole through which low linear mass and low speed of light hyperspace energy can enter the hull in order to create highly relativistic electromagnetic fields.

8. A variable current generator to modulate the direct current in the coil so as to produce a variable magnetic moment that can control lift, hover and descent.

9. An electrical power supply using mechanical flywheel stored energy together with a large area capacitor, resupplied with energy by solar cells located on the outer surface of the hull.
